(19) United States
(12) Patent Application Publication
(10) Pub. No.: US 2004/0012321 A1
(43) Pub. Date: Jan. 22, 2004

(54) Fe-Ni alloy material for shadow mask and method for manufacturing thereof

(75) Inventors: Ikuya Kurosaki, Hitachi-shi (JP); Takashi Shibata, Muroran-shi (JP); Shinji Tanaka, Muroran-shi (JP)

Correspondence Address: MILLEN, WHITE, ZELANO & BRANIGAN, P.C., 2200 CLARENDON BLVD., SUITE 1400, ARLINGTON, VA, 22201, US

(73) Assignees: NIPPON MINING METALS CO LTD, Tokyo (JP); JAPAN STEEL WORKS CO LTD, Tokyo (JP)

(21) Appl. No.: 10/618,724

(22) Filed: Jul. 15, 2003

(30) Foreign Application Priority Data
Jul. 15, 2002 (JP) 2002-205925

(51) Int. Cl. H01J 29/80; C22C 38/16; C22C 38/20; C22C 38/42; C22C 38/08; C21D 9/08; C21D 6/00; C21D 8/00

(52) U.S. Cl. 313/402; 148/332; 148/336; 148/590; 148/621

(57) ABSTRACT

An Fe—Ni alloy material for a shadow mask having, in terms of % by weight, 34.0 to 38.0% of Ni, 0.05 to 0.45% of Cu, 0.10 to 0.50% of a combined total for Mn and Cu, no more than 0.10% of Si and 0.0004 to 0.005% of S with the balance being Fe and other unavoidable impurities; wherein a total count of MnS precipitates and Cu—S type precipitates having a diameter of 0.01 to 3 μm located on the surface of a foil strip 0.05 to 0.3 mm thick being at least 2,000 count/mm².

### BACKGROUND OF THE INVENTION

1. Field of the Invention

The present invention relates to an Fe—Ni alloy material for a shadow mask processed using micro etching and method for manufacturing thereof. More specifically, this invention relates to an Fe—Ni alloy material for a shadow mask which has electron beam transmission apertures of uniform hole diameters when electron beam transmission apertures are pierced using an etching process. In addition, the present invention relates to an Fe—Ni alloy material for a shadow mask which can suppress, due to a small thermal expansion coefficient, electron beam drifting at elevated temperatures reached while using a shadow mask. Furthermore, the present invention relates to a high strength Fe—Ni alloy material for a shadow mask that can apply flattening of shadow masks in response to the flattening in color Braun tubes.

2. Description of the Prior Art

Mild steel has been commonly used in conventional shadow masks for color Braun tubes. However, the continuous use of Braun tubes results in a rising shadow mask temperature caused by electron beam irradiation, and the thermal expansion of the shadow mask result on out of color registration shifts in fluorescent materials and the electron beam irradiated positions. That is, no more than one third of the total electron beam would pass through the open holes in a shadow mask when a color imaging tube was activated, and the balance of the rising temperature of the shadow mask is caused by more than two thirds of the total electron beam bombarded the shadow mask.

Therefore, recently, in the field of color Braun tube shadow masks, Fe—Ni alloys referred to as “36 alloy” or “Invar alloy” having low coefficient of thermal expansion have been used to prevent out of color registration. In addition, alloys prepared by replacing a portion of Ni in Fe—Ni alloys with Co have been used to further reduce coefficient of thermal expansion.

As the method of manufacturing an Fe—Ni alloy material for a shadow mask, a prescribed Fe—Ni alloy was melted by vacuum fusion using a VIM furnace or melted by scouring outside the furnace using an LF, and then it was cast into ingots, forged, hot rolled, oxide scales on the slab surface removed and repeatedly cold rolled and annealed (recrystallization annealing). The process was completed by executing a final cold rolling after a final recrystallization annealing to yield a sheet having a prescribed thickness of no thicker than 0.3 mm. The material was subsequently slit to obtain a shadow mask material having a prescribed sheet width. The shadow mask material was degreased, a photo resist was applied on both sides and a pattern was printed and developed, and the materials were treated using an etching reagent to pierce holes and were then cut into individual flat masks. The flat masks were annealed in a non-oxidizing atmosphere to impart a press processing property and were pressed into spherical mask shapes. The spherical press formed masks were degreased, and a black oxide film was formed on the surface upon subjecting it to a blackening treatment in a water vapor or combustion gas atmosphere to prepare a shadow mask in the manner described above.

Electron beam transmission apertures on the shadow masks described above were generally formed using a well-known etching process involving an aqueous ferric chloride solution. The etching process was carried out by utilizing a photolithography technique, namely, a resist mask containing numerous truly circular openings having a diameter of 80 μm, for example, on one side of an alloy strip and truly circular openings having a diameter of 180 μm, for example, in corresponding locations on the other surface was formed, and then, the shadow mask having resist mask was subsequently sprayed with an aqueous ferric chloride solution.

A shadow mask containing tightly oriented minute openings was obtained using this etching process, but the hole diameters were not uniform due to localized variations in etching conditions. When the variation was extensive, the out of color registration observed upon incorporating the shadow mask into Braun tubes, and this out of color registration made them commercially unacceptable. The broad variance in hole diameters was normally the main cause for a lowered yield and increased manufacturing cost in the etching process for a shadow mask.

Many studies have been undertaken in the past to improve the etching process to create piercing holes. As far as materials are concerned, a proposal wherein crystal orientation was randomized by using an aggregation degree for the {100} plate in a rolled surface of less than 35% was presented in Japanese Patent Provisional Publication No. 05-311357. In addition, a proposal to regulate the total inclusions length in the direction of rolling per unit area of the cross section parallel to rolling was presented in Japanese Patent Provisional Publication No. 05-311358. In addition, a proposal to improve hole piercing properties in an etching process by regulating Mn and S concentrations in addition to Si and C contents as well as the cleanliness of cross section of oxide inclusions was presented in Japanese Patent Provisional Publication No. 07-207415. The proposals represented arts relate to the regulation of the whole texture and inclusions.

The results of studies conducted by the inventors and others, however, confirmed that the above art could not prevent etching defects from appearing in some sections. The etching defects encountered were caused by localized excessive etching around opening peripheries and resulted in opening diameter deviations around electron beam transmission apertures. When such etching defects occurred, the opening diameters exceeded target sizes and the hole vicinity appeared to glow brightly when one looked through a shadow mask after electron beam transmission apertures were formed by etching.

### SUMMARY OF THE INVENTION

Therefore, an object of the present invention is to provide an Fe—Ni alloy material that can minimize the non-uniformity in pierced hole diameters formed by etching as the localized etching defects when forming electron beam transmission apertures using an etching process, and to provide a method of manufacturing thereof. In addition, another object of the present invention is to provide an Fe—Ni alloy material for a shadow mask having a small coefficient of thermal expansion capable of minimizing electron beam drifting at elevated temperatures when a shadow mask is in use, and having high strength so that it can sufficiently endure shadow mask flattening accompanying color Braun tube flattening.

In order to achieve the above objects, the inventors extensively researched the cause of localized etching defects from completely new perspectives previously overlooked. As a result, the minute precipitates in a material were found to exert a profound influence when forming electron beam transmission apertures in an Fe—Ni alloy material by etching. That is, the inventors discovered that localized etching defects manifest as a broad distribution of diameters of etched penetrating openings could be suppressed in an Fe—Ni alloy material containing a great number of minute precipitates. The precipitates act as starting points of erosion during etching, and starting points of etching are uniformly dispersed and the diameter distribution of etched penetrating openings is narrowed when said precipitates are minutely and uniformly distributed.

The Fe—Ni alloy material for a shadow mask of the present invention is developed based on the above findings and comprising: in terms of % by weight, 34.0 to 38.0% of Ni, 0.05 to 0.45% of Cu, 0.10 to 0.50% of a combined total for Mn and Cu, no more than 0.10% of Si and 0.0004 to 0.005% of S with the balance being Fe and other unavoidable impurities; wherein a total count of MnS precipitates and Cu—S type precipitates having a diameter of 0.01 to 3 μm located on the surface of a foil strip 0.05 to 0.3 mm thick being at least 2,000 count/mm².

In accordance with another feature of the present invention, there is provided an Fe—Ni alloy material for a shadow mask, comprising: in terms of % by weight, 30.5 to 34.5% of Ni, 35.0 to 38.0% of a combined total of Ni and Co, 0.05 to 0.45% of Cu, 0.10 to 0.50% of a combined total of Mn and Cu, no more than 0.10% of Si and 0.0004 to 0.005% of S with the balance being Fe and other unavoidable impurities; wherein a total count of MnS precipitates and Cu—S type precipitates having a diameter of 0.01 to 3 μm located on the surface of a foil strip 0.05 to 0.3 mm thick being at least 2,000 countlmm².

Preferably, the Fe—Ni alloy material for a shadow mask contains 0.10 to 1.0% by weight of Nb.

In accordance with further another feature of the present invention, there is provided a method for manufacturing Fe—Ni alloy material for a shadow mask, wherein: a material temperature of 650 to 1000° C. during recrystallization annealing.

### BRIEF DESCRIPTION OF THE DRAWINGS

FIG. 1 is a graph showing the relationship between the heat treatment temperature and pit density for sample No. 6 of the present invention.

### DETAILED DESCRIPTION OF THE INVENTION

The bases for the aforementioned numerical limitations along with the action of the present invention are explained below. The term “%” refers to “% by weight” in the explanation below.

Ni: 34.0-38.0%

When the Ni concentration is less than 34.0% or exceeds 38.0%, the coefficient of thermal expansion rises and the product obtained can not be used as a shadow mask. Therefore, the Ni concentration is restricted to 34.0 to 38.0%.

Mn+Cu: 0.10-0.50%

Cu and Mn improve etching properties by forming an MnS precipitates that is a compound of Mn with S, and by forming a Cu—S type precipitates. In this case, Mn is added as a deoxidizing agent, and, by forming MnS with S which deteriorates hot workability, Mn effectively let S harmless. Furthermore, minutely precipitated MnS in an Fe—Ni alloy acts as etching starting points, and the presence of numerous precipitated starting points is effective in facilitating uniform etching. Mn and Cu are added to improve etching properties, but the sum of the amount added must be regulated since their presence raises the coefficient of thermal expansion when too much is added. That is, etching properties are insufficiently improved when the sum of Mn and Cu concentrations is less than 0.10%, and the coefficient of thermal expansion is too high when it exceeds 0.50%. Therefore, the sum of Mn and Cu concentrations should be 0.10% to 0.50%.

Cu: 0.05-0.45%

Cu improves the etching properties by allowing a compound with S to be precipitated in an alloy as Mn did as described above. Since Cu does not raise the coefficient of thermal expansion as much as Mn, Cu is aggressively added. No improvement is realized in etching when the concentration is less than 0.05%, and the magnetic properties declines when it exceeds 0.45%. Therefore, the Cu concentration is limited to 0.05% to 0.45%.

Si: No More Than 0.10%

Si is an element added as a deoxidizing agent as is Mn. However, the upper limit of Si concentration is set at 0.10% since the etching properties declines when the Si concentration exceeds 0.10%.

S: 0.0004-0.005%

S allows MnS precipitates and Cu—S type precipitates capable of improving etching properties to be precipitated, but is not sufficiently effective when the concentration is less than 0.0004%, and deteriorates hot workability when the concentration exceeded 0.005%. Therefore, the S concentration is set at 0.0004 to 0.005%.

MnS Precipitates and Cu—S Type Precipitates

The dispersion of MnS precipitates and Cu—S type precipitates allows nearly truly circular holes to be etched, because the MnS precipitates and Cu—S type precipitates present in the vicinity of or just over a photo resist mask opening outline act as etching starting points. Therefore, a broad range of aperture diameter for etched penetrating openings caused by localized etching defects is suppressed. In order to achieve this effect, MnS precipitates and Cu—S type precipitates needed to be present in the aforementioned sites at least the designated frequency. Therefore, the sum of individual precipitates counts is set at at least 2,000 count/mm².

MnS precipitates and Cu—S type precipitates having a diameter smaller than 0.01 μm do not act as etching starting points. In addition, aperture diameter uniformity is adversely affected due to damage to etching aperture outlines when the diameter exceeds 3 μm. Thus, the diameter of the aforementioned precipitates on a foil strip surface is set at 0.01 to 3 μm.

Thus, in the present invention, excellent opening diameter uniformity for etched penetrating openings and significantly improved etching properties are realized since MnS precipitates and Cu—S type precipitates are dispersed as described above under designated conditions. In addition, the Mn concentration can be reduced and the coefficient of thermal expansion lowered by having Cu present at 0.05 to 0.45%. The Cu—S type precipitates were identified using a X-ray diffraction pattern, and results indicated the presence of a multiple number of compounds such as CuS, Cu₂S and the like, and they are collectively referred as Cu—S type compounds. So as the above Cu—S type precipitates, the composition shown in a binary phase diagram for Cu—S can be cited as an example. As far as more specific compositions are concerned, Cu₂S or non-stoichiometric compositions of Cu and S or the like may be mentioned but are not limited to these examples.

Here, the MnS and Cu—S type inclusions(include precipitates) in a material can be observed using a transmission electron microscope using the procedure described below.

1) A sample surface is electropolished at a low potential. The electropolishing process is referred to as a SPEED method, which a sample surface is electrified in an organic solvent (10% acetyl acetone-1% tetramethyl ammonium chloride-methyl alcohol) at +100 mV vs SCE , 2.5 coulomb/cm² , and the sample surface is dissolved. The electropolishing dissolves only the Fe—Ni basis and the inclusions which are not dissolved by the electropolishing are present as protrusions from the polished surface.

2) Acetyl cellulose is applied on an electropolished surface and peeled, and the protrusions of inclusions adhere to the acetyl cellulose.

3) Carbon is deposited on the surface of the acetyl cellulose which inclusions are adhered to, and the acetyl cellulose is immersed in methyl acetate to dissolve the acetyl cellulose.

4) The thin carbon film containing the inclusions is examined using a transmission electron microscope, and the form of the inclusions is observed. In addition, the inclusion composition is identified using EDS and electron beam diffraction.

In the present invention, the materials subjected to etching to pierce electron beam transmission apertures after a final cold rolling are collectively referred to as materials for shadow mask. In addition, materials for which electron beam transmission apertures were formed prior to press forming, including flat masks, are included as materials for shadow masks.

Other Characteristics

Here, a portion of Ni may be replaced with Co in the present invention, and the coefficient of thermal expansion can be further reduced. The present invention includes such embodiments and is an Fe—Ni alloy material for a shadow mask, comprising: in terms of % by weight, 30.5 to 34.5% of Ni, 35.0 to 38.0% of a combined total of Ni and Co, 0.05 to 0.45% of Cu, 0.10 to 0.50% of a combined total of Mn and Cu, no more than 0.10% of Si and 0.0004 to 0.005% of S with the balance being Fe and other unavoidable impurities; wherein a total count of MnS precipitates and Cu—S type precipitates having a diameter of 0.01 to 3 μm located on the surface of a foil strip 0.05 to 0.3 mm thick being at least 2,000 count/mm².

The sum concentration of Ni and Co was regulated as described above since the coefficient of thermal expansion rises and the effect of lowering the coefficient of thermal expansion by Co addition fails when the concentration exceeded the aforementioned range, although Co lowered the coefficient of thermal expansion and this effect can be expressed in terms of the total concentration of Co and Ni. In this case, an alloy having an even lower thermal expansion coefficient is obtained when 3 to 6% of Co is added and the sum of Ni and Co is 35 to 37%.

Other Elements

Nb can be added in the present invention to increase the shadow mask strength. In this case, no improvement in strength is observed when the Nb concentration is less than 0.10%, and press forming is difficult when the concentration exceeds 1.0% due to an excessive rise in the strength. So, preferably, the Nb concentration is 0.10 to 1.0%. Now, the additions of Ti, Hf and Ta in addition to Nb are also effective, and effects similar to that of Nb addition are realized.

In addition, the C concentration is preferably limited to no more than 0.01% since C forms carbides and etching properties decline, the P concentration is preferably limited to no more than 0.01% since the presence of excessive P resulted in etching property declines and the Al concentration is preferably limited to no more than 0.03% since Al forms oxides and nitrides that interfere with etching.

In order to obtain minute precipitates(include inclusions) which exist over an entire material, not only adding the aforementioned specific elements but also perform the heat treatment and processing at appropriate conditions during the process from melting and casting step to forming a foil strip product step. The inventors extensively investigated minute precipitates and inclusions in a material by combining various elements and various conditions of heat treatment and processing. As a result, the inventors discovered that numerous minute MnS precipitates and Cu—S type precipitates can be formed in a product by adding correct amounts of Mn, Cu and S, conducting repeated cold rolling and recrystallization annealing steps after hot rolling an Fe—Ni alloy slab, and by finishing to a prescribed thickness in the final cold rolling, by rectifying the material heat hysteresis, particularly rectifying the heating conditions during recrystallization annealing.

That is, the present invention is a method of manufacturing the aforementioned Fe—Ni alloy material for a shadow mask, wherein the temperature of the material during recrystallization annealing at 650 to 1000° C. (degree. C.).

The Fe—Ni alloy materials used in shadow masks are ordinarily from 0.05 to 0.30 mm thick and are finished to a product thickness by subjecting a sheet 2 to 6 mm thick after hot rolling to repeated cold rolling and recrystallization annealing processes followed by a final cold rolling. The recrystallization annealing condition is required to be appropriate in order to precipitate MnS precipitates and Cu—S type precipitates minutely in the present invention.

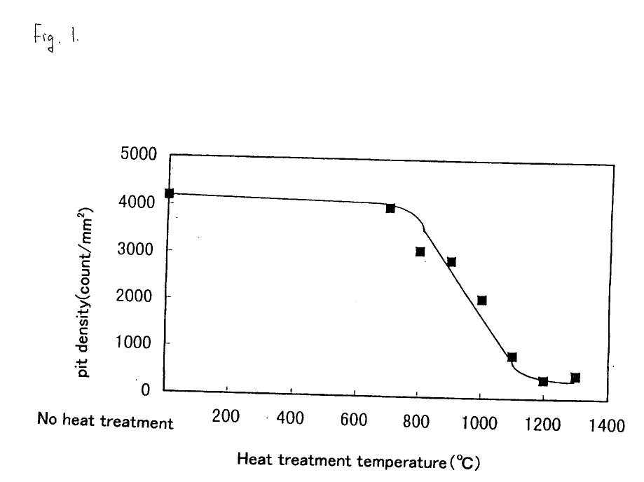

The recrystallization annealing is conducted at 650 to 1000° C. The solubility product of Mn and S in a solid solution ([%Mn]×[%S]) and the solubility product of Cu and S in a solid solution ([%Cu]×[%S]) in an Fe—Ni alloy change suddenly in a 1000 to 1200° C. temperature range. That is, MnS precipitates and Cu—S type precipitates are readily dissolved in an Fe—Ni alloy in the form of a solid solution at temperatures higher than 1200° C., but much of the MnS precipitates and Cu—S type precipitates precipitate at temperatures at or below 1000° C. FIG. 1 presents the foundation data indicating that the pit density is at least 2,000 count/mm² when the heat treatment temperature is at or below 1000° C. Therefore, etching properties are adversely affected due to further solid dissolution of MnS precipitates and Cu—S type precipitates when the recrystallization annealing temperature exceeds 1000° C. Still, a pit comes into view as the eroded holes (pits) of precipitates and inclusions which are formed when a sample was immersed in an acidic solution such as dilute hydrochloric acid, dilute sulfuric acid and the like and a potential in an activated dissolution region was applied for several seconds to several tens of seconds to cause anodic dissolution. Therefore, occurrence of precipitates and inclusions can be evaluated according to the pit density (count/mm²).

On the other hand, an extended time is needed to adjust the material to a prescribed grain size or recrystallization did not proceed sufficiently when the recrystallization annealing temperature was below 650° C. The recrystallization annealing can be conducted either by using a continuous annealing line at high temperatures over a short span of time or by using a batch type annealing furnace at lower temperatures over an extended period of time. In either case, the heating furnace interior needs to be filled with gaseous hydrogen or a reducing gas containing hydrogen or an inert gas such as Ar and the like in order to prevent oxidation of the material surface. In addition, recrystallized grain size upon annealing needs to be adjusted to a set range, for example, 5 to 30 μm of average grain size. Here, the average recrystallized grain size refers to the grain size in a cross section parallel to the direction of rolling measured according to the intercept method described in Japanese Industrial Standards JIS H 0501.

Conducting all recrystallization annealing steps at 650 to 1000° C. is desirable for increasing the amount of MnS precipitates and Cu—S type precipitates, but a large amount of the precipitates can be obtained by conducting only the final recrystallization annealing at 650 to 1000° C.

Correcting heat hysteresis during hot rolling could further introduce minute precipitations into Fe—Ni alloys. Hot rolling of Fe—Ni alloys is ordinarily conducted at 950 to 1250° C., but much of the MnS precipitates and Cu—S type precipitates are in solid solution in this temperature range. So, MnS precipitates and Cu—S type precipitates can be allowed to precipitate during a cooling step by gradually cooling a sheet after hot rolling. In addition, annealing without accompanying recrystallization, for example, an aging treatment or a stress relief annealing is a powerful method to accelerate and increase precipitation of MnS precipitates and Cu—S type precipitates.

Furthermore, the reduction ratio of a final cold rolling of 10 to 40% is desirable. When the reduction ratio is less than 10%, a uniform recrystallized grain is not formed, and a non-recrystallized grain remained in the annealing step intended to impart press forming properties immediately preceding a press processing. In addition, when the reduction ratio exceeds 40%, a rolled texture developed to an extreme degree and the etching rate declined.

### EXAMPLES

The present invention is explained in further detail by presenting specific examples below.

Ingots adjusted to contain 31.9 to 36.5% of Ni, 0.01 to 5.2% of Co, 0.03 to 0.42% of Mn, 0.01 to 0.45% of Cu, 450 to 680 ppm of Si, 3 to 53 ppm of S and less than 0.01 to 1.12% of Nb were cast by using VIM. Next, these ingots were hot forged and then hot rolled. The oxide scale on the surface was subsequently removed, and cold rolling and recrystallization annealing were repeated with a final rolling conducted to manufacture an alloy strip 0.2 mm thick.

The alloy was rolled to 4 mm after heating it to 1100° C. in a hot rolling step, and the average cooling rate in a following cooling step was no faster than 0.5° C./second from 900 to 700° C. The final recrystallization annealing was conducted for one to ten minutes at 550 to 1100° C., and the average grain size was adjusted to be from 5 to 30 μm. In addition, recrystallization annealing steps other than the final one were conducted at 950° C. The annealing described above was conducted in a reducing atmosphere composed of 25% H₂—N₂. As far as cold rolling was concerned, the reduction ratio of the final cold rolling was 25%. The reduction ratio of the cold rolling here was calculated using (t₀−t)/t₀×100 (%) wherein tₒ indicated the thickness prior to cold rolling and t indicated the thickness after cold rolling.

A foil strip prepared as described above was electrified at +100 mV vs SCE, 2.5 coulombs/cm² in an organic solvent (10% acetyl acetone-1% tetramethyl ammonium chloride-methyl alcohol) to dissolve the sample surface, and the density at which 0.01-3 μm precipitates size was present was evaluated using the method described above.

A commonly known photolithography technique was used on the alloy strip manufactured using the aforementioned process, and a resist mask containing numerous truly round openings 80 μm in diameter on one surface and containing truly round openings 180 μm in diameter in corresponding locations on the other surface was formed. An aqueous ferric chloride solution was subsequently sprayed to etch penetrating openings, and one hundred sheets of fourteen inch mask materials were prepared. Mask materials containing zero defective masks per 100 mask materials were ranked (1), those containing one to five defective masks were ranked (2), those containing six to ten defective masks were ranked (3) and those containing at least eleven defective masks were ranked (4). Here, mask materials ranked (1) through (3) were regarded as good products, and mask materials ranked (4) were regarded as poor products. The chemical compositions of the aforementioned alloy strips are shown in Table 1, the recrystallization annealing temperatures, the thermal expansion coefficients measured prior to etching, the counts of precipitates and 0.2% yield strengths measured after conducting recrystallization annealing simulating that of actual shadow masks after the final rolling are shown in Table 2.

Samples No. 1-7, as shown by the data in Table 1, produced “good products” having low etching defect generation frequency since the composition and precipitates counts were within the range specified in the present invention. The compositions or precipitates counts for samples No. 8-15, however, exceeded the ranges specified in the present invention, and “poor products” having high etching defect generation frequency were obtained. Sample No. 8 had the same chemical components as sample No. 2, but the recrystallization annealing temperature was 1100° C., exceeding the upper limit of the present process invention. As a result, the precipitates count declined because the precipitates solved in the solid solution again, and the etching defect generation frequency rose.

The Cu concentration in sample No. 9 was 0.05%, the lower limit in the present invention, but the sum of Mn and Cu concentrations was below the lower limit (0.10%). As a result, the count for the MnS precipitates and Cu—S type precipitates effective in improving etching properties decreased to less than 2,000 counts/mm² and resulted in a high etching defect generation frequency

The S concentration in sample No. 10 was 3 ppm and was below the lower limit (4 ppm) for the present invention. As a result, the count for MnS precipitates and Cu—S type precipitates effective in improving etching properties decreased to less than 2,000 counts/mm² and resulted in a high etching defect generation frequency.

The sum of Mn and Cu in sample No. 11 exceeded the upper limit (0.50%) for the present invention, and the coefficient of thermal expansion was higher than those of examples of the present invention although no etching property problem was encountered. In addition, the Cu concentration in sample No. 12 was below the lower limit (0.05%) of the present invention, and the sum of Mn and Cu also was lower than the lower limit (0.10%) of the present invention. As a result, the count for MnS precipitates and Cu—S type precipitates effective in improving etching properties decreased to less than 2,000 counts/mm² and resulted in a high etching defect generation frequency. Furthermore, in this sample, the sum of Ni and Co exceeded the upper limit (38.5%) for the present invention, and the coefficient of thermal expansion rose to a level higher than those of examples of the present invention.

The sum of Mn and Cu in sample No. 13 was below the lower limit (0.10%) of the present invention. As a result, the count for MnS precipitates and Cu—S type precipitates effective in improving etching properties decreased to less than 2,000 counts/mm² resulted in a high etching defect generation frequency. Furthermore, in this sample, the total amount of elements such as Nb exceeded the upper limit (1.0%) of the preferable embodiment of the present invention resulting in a higher 0.2% yield strength than those of examples of the present invention, and the press processing was difficult to perform.

The S concentration for sample No. 14 exceeded the upper limit (50 ppm) for the present invention. As a result, performance goals could not be realized due to poorer hot workability, crack formation during hot rolling at sample adjustments process, and an inability to undergo subsequent processing. Sample No. 15 contained the same chemical compositions found in samples No. 6 and 7, but the recrystallization annealing temperature was 550° C., falling under the lower limit (650° C.) of the present process invention. As a result, evaluation targets were not realized even when a sample was heated for an extended period of time since the average grain size during recrystallization annealing did not meet the specification of at least 5 μm.

Broad distributions in etched aperture size due to localized etching defects can be minimized according to the present invention as described above when etching electron beam transmission apertures. In addition, effects of the present invention include low coefficient of thermal expansion, capability to minimize electron beam drifting at elevated temperatures reached while using a shadow mask, and high strength, enable the shadow mask to respond to color Braun tube flattening.

TABLE 1

| | | | | | | | | | | |
|---|---|---|---|---|---|---|---|---|---|---|
| Sample | | | | | | | | | | |
| No. | Ni (%) | Co (%) | Mn (%) | Nb (%) | Cu (%) | S (ppm) | Si (ppm) | Al (ppm) | O (ppm) | C (ppm) |

Examples of the present invention

| | | | | | | | | | | |
|---|---|---|---|---|---|---|---|---|---|---|
| 1 | 36.5 | <0.01 | 0.14 | <0.01 | 0.31 | 15 | 580 | 200 | 45 | 30 |
| 2 | 32.1 | 4.9 | 0.26 | <0.01 | 0.10 | 30 | 620 | 240 | 35 | 25 |
| 3 | 32.7 | 3.1 | 0.07 | <0.01 | 0.05 | 4 | 510 | 210 | 45 | 35 |
| 4 | 32.1 | 4.8 | 0.12 | 0.29 | 0.10 | 6 | 600 | 210 | 45 | 25 |
| 5 | 31.9 | 5.2 | 0.25 | 0.32 | 0.05 | 18 | 680 | 190 | 40 | 40 |
| 6 | 32.1 | 4.8 | 0.03 | <0.01 | 0.45 | 15 | 450 | 210 | 50 | 35 |
| 7 | 32.1 | 4.8 | 0.03 | <0.01 | 0.45 | 15 | 450 | 210 | 50 | 35 |

Comparative examples

| | | | | | | | | | | |
|---|---|---|---|---|---|---|---|---|---|---|
| 8 | 32.1 | 4.9 | 0.26 | <0.01 | 0.10 | 30 | 620 | 240 | 35 | 25 |
| 9 | 32.2 | 5.1 | 0.03 | <0.01 | 0.05 | 18 | 590 | 160 | 45 | 40 |
| 10 | 36.0 | 0.02 | 0.25 | <0.01 | 0.10 | 3 | 550 | 210 | 50 | 30 |
| 11 | 35.8 | 0.02 | 0.42 | <0.01 | 0.13 | 5 | 510 | 190 | 50 | 35 |
| 12 | 35.5 | 5.2 | 0.06 | <0.01 | 0.03 | 14 | 580 | 240 | 50 | 25 |
| 13 | 31.9 | 5.2 | 0.03 | 1.12 | 0.01 | 18 | 490 | 190 | 50 | 30 |
| 14 | 35.5 | 4.9 | 0.08 | <0.01 | 0.03 | 53 | 540 | 210 | 45 | 35 |
| 15 | 32.1 | 4.8 | 0.03 | <0.01 | 0.45 | 15 | 450 | 210 | 50 | 35 |

TABLE 2

| | | | | | |
|---|---|---|---|---|---|
| | Coefficient of | | | | |
| | thermal expansion | 0.2% yield | | Recrystallization | |
| | α₃₀₋₁₀₀ | strength | Precipitates count | annealing material | Frequency of etching defect |
| Sample No. | × 10⁻⁶/° C. | MPa | count/mm² | temperature ° C. | generation |

Examples of the present invention

| | | | | | |
|---|---|---|---|---|---|
| 1 | 0.7 | 260 | 16,000 | 850 | Rank 1 (good product) |
| 2 | 0.4 | 290 | 18,000 | 850 | Rank 1 (good product) |
| 3 | 0.5 | 300 | 6,400 | 850 | Rank 2 (good product) |
| 4 | 0.5 | 330 | 11,000 | 850 | Rank 1 (good product) |
| 5 | 0.7 | 340 | 2,300 | 1000 | Rank 3 (good product) |
| 6 | 0.3 | 290 | 14,000 | 850 | Rank 1 (good product) |
| 7 | 0.4 | 290 | 21,000 | 600 | Rank 1 (good product) |

Comparative examples

| | | | | | |
|---|---|---|---|---|---|
| 8 | 0.7 | 290 | 880 | 1100 | Rank 4 (poor product) |
| 9 | 0.3 | 280 | 340 | 850 | Rank 4 (poor product) |
| 10 | 1.1 | 270 | 1,700 | 850 | Rank 4 (poor product) |
| 11^{*1} | 1.4 | 270 | 18,000 | 850 | Rank 1 (good product) |
| 12 | 1.2 | 300 | 670 | 850 | Rank 4 (poor product) |
| 13 | 0.5 | 360 | 480 | 850 | Rank 4 (poor product) |
| 14^{*2} | — | — | — | — | — |
| 15^{*3} | — | — | — | 550 | — |

^{*1}Extensive thermal expansion made this a poor product.
^{*2}The material cracked during hot rolling and could not be evaluated.
^{*3}Recrystallization did not proceed sufficiently, and the evaluation was impossible.

What is claimed is:

1. An Fe—Ni alloy material for a shadow mask, comprising: in terms of % by weight, 34.0 to 38.0% of Ni, 0.05 to 0.45% of Cu, 0.10 to 0.50% of a combined total for Mn and Cu, no more than 0.10% of Si and 0.0004 to 0.005% of S with the balance being Fe and other unavoidable impurities; wherein a total count of MnS precipitates and Cu—S type precipitates having a diameter of 0.01 to 3 μm located on the surface of a foil strip 0.05 to 0.3 mm thick being at least 2,000 count/mm².

2. An Fe—Ni alloy material for a shadow mask, comprising: in terms of % by weight, 30.5 to 34.5% of Ni, 35.0 to 38.0% of a combined total of Ni and Co, 0.05 to 0.45% of Cu, 0.10 to 0.50% of a combined total of Mn and Cu, no more than 0.10% of Si and 0.0004 to 0.005% of S with the balance being Fe and other unavoidable impurities; wherein a total count of MnS precipitates and Cu—S type precipitates having a diameter of 0.01 to 3 μm located on the surface of a foil strip 0.05 to 0.3 mm thick being at least 2,000 count/mm².

3. An Fe—Ni alloy material for a shadow mask according to claims 1, wherein: containing 0.10 to 1.0% by weight of Nb.

4. An Fe—Ni alloy material for a shadow mask according to claims 2, wherein: containing 0.10 to 1.0% by weight of Nb.

5. A method for manufacturing Fe—Ni alloy material for a shadow mask according to claims 1, wherein: a material temperature of 650 to 1000° C. during recrystallization annealing.

6. A method for manufacturing Fe—Ni alloy material for a shadow mask according to claims 2, wherein: a material temperature of 650 to 1000° C. during recrystallization annealing.

7. A method for manufacturing Fe—Ni alloy material for a shadow mask according to claims 3, wherein: a material temperature of 650 to 1000° C. during recrystallization annealing.

8. A method for manufacturing Fe—Ni alloy material for a shadow mask according to claims 4, wherein: a material temperature of 650 to 1000° C. during recrystallization annealing.
